(19) United States
(12) Patent Application Publication
(10) Pub. No.: US 2017/0210867 A1
(43) Pub. Date: Jul. 27, 2017

(54) COATINGS AND COATED SUBSTRATES WITH IMPROVED BARRIER AND ADHESION CHARACTERISTICS, AND METHODS OF PRODUCING THE SAME

(71) Applicant: Michelman, Inc., Cincinnati, OH (US)

(72) Inventors: Robin Cooper, Attert (BE); Francis Jacques, Rouvrois sur Othain (FR)

(21) Appl. No.: 15/408,778

(22) Filed: Jan. 18, 2017

Related U.S. Application Data
(60) Provisional application No. 62/286,051, filed on Jan. 22, 2016.

(51) Int. Cl. C08J 7/04; B05D 3/00; C09D 5/00; C09D 129/04; C09D 7/12

(52) U.S. Cl. CPC C08J 7/047; C09D 129/04; C09D 7/125; C09D 5/002; B05D 3/007; C08J 2367/03; C08J 2429/04; C08J 2479/02

(57) ABSTRACT

Embodiments of the present disclosure are directed to primer coatings, polymeric substrates, and methods of producing thereof, which provide enhanced adhesion and enhanced barrier properties. The primer coatings comprise an aqueous mixture of amorphous polyvinyl alcohol, an adhesion promoter comprising one or more of polyethylene and polyurethane, a crosslinker, and optionally, a catalyst. The coated polymeric substrates comprise a polymeric substrate and a coating dispersed over the polymeric substrate, where the coating dispersed over the polymeric substrate comprises amorphous polyvinyl alcohol, an adhesion promoter, and a crosslinker. The methods for making coated polymeric substrates comprise stretching a polymeric substrate, applying a coating of amorphous polyvinyl alcohol, an adhesion promoter, and a crosslinker to at least one surface of the stretched polymeric substrate, and curing the coating onto at least one surface of the stretched polymeric substrate.

### CROSS-REFERENCE TO RELATED APPLICATIONS

This application claims priority to U.S. Provisional Application Ser. No. 62/286,051, filed Jan. 22, 2016, which is incorporated by reference in its entirety herein.

### TECHNICAL FIELD

Embodiments of the present disclosure generally relate to coatings and coated substrates with improved barrier and adhesion characteristics, and methods of producing the same. Specifically, embodiments generally relate to primer coatings, coated polymeric substrates, and methods of making coated polymeric substrates with an improved oxygen transmission rating and metal adhesion bond strength.

### BACKGROUND

Thermoplastic polymer films such as polyamide and polyester films have excellent strength and transparency and are widely used as packaging materials for food, cosmetics, medicine and the like. However, such films are relatively permeable to gases such as oxygen. During storage, gases can permeate the film and interact with the package contents, causing degradation.

Gas barrier coatings or primers are used on polymeric substrates to provide a barrier in packaging to prevent degradation of the product. One known gas barrier coating is crystalline polyvinyl alcohol, which exhibits gas barrier properties under low humidity conditions. However, as the humidity increases, the gas barrier properties of the coating decline rapidly. Another known gas barrier coating is a metallized coating. Such a coating typically comprises a thin layer of aluminum which is applied to a substrate by vacuum deposition. Such a metallized coating reduces the permeability of the polymeric film substrate to light, water and oxygen. However, it would be desirable to improve the adhesion of metallized coatings to the substrate and to improve the gas barrier properties of such coatings.

### SUMMARY

Accordingly, there is a need in the art for primer coatings for use on polymeric substrates that are receptive to subsequently applied metallized coatings and enhance the barrier properties of the substrate to which it is applied. Embodiments of the present disclosure meet these needs by providing a primer coating which can be applied to polymeric substrates to provide enhanced adhesion of a metallized coating to the substrate and that provides enhanced barrier properties for the coated polymeric substrate.

According to one aspect of the present disclosure, a primer coating is provided that includes an aqueous mixture of amorphous polyvinyl alcohol, an adhesion promoter comprising one or more of polyethylene and polyurethane, a crosslinker, and optionally, a catalyst.

In another aspect of the present disclosure, a coated polymeric substrate is provided that includes a polymeric substrate and a coating dispersed over the polymeric substrate, where the coating that is dispersed over the polymeric substrate comprises amorphous polyvinyl alcohol, an adhesion promoter comprising one or more of polyethylene and polyurethane, and a crosslinker.

According to another aspect of the present disclosure, a method is provided that includes stretching a polymeric substrate, applying a coating of amorphous polyvinyl alcohol, an adhesion promoter comprising one or more of polyethylene and polyurethane, and a crosslinker to at least one surface of the stretched polymeric substrate, and curing the coating onto at least one surface of the stretched polymeric substrate.

Additional features and advantages of the described embodiments will be set forth in the detailed description which follows, and in part will be readily apparent to those skilled in the art from that description or recognized by practicing the described embodiments, including the detailed description which follows, the claims, and the figures.

### BRIEF DESCRIPTION OF THE DRAWINGS

FIG. 1 is a graph of differential scanning calorimetry (DSC) data, measuring temperature in degrees Celsius (° C.) and heat flow in watts per gram (W/g) to show the crystalline peaks and glass transition peaks of examples according to embodiments disclosed and described herein and two comparative examples; and

FIG. 2 is a graph of DSC data, measuring temperature (° C.) and heat flow (W/g) to show the crystalline peaks and glass transition peaks of examples according to embodiments disclosed and described herein at varying temperatures.

### DETAILED DESCRIPTION

Embodiments of the present disclosure are directed to primer coatings which may be applied to polymeric substrates to provide enhanced adhesion of a metallized coating to the substrate and enhanced barrier properties for the coated polymeric substrate, and methods of producing the same.

The following description of the embodiments is illustrative in nature and in no way intended to be limiting it its application or use. Unless otherwise indicated, the disclosure of any ranges in the specification and claims are to be understood as including the range itself and also values subsumed therein, as well as endpoints.

One embodiment of the present disclosure includes, among other things, a primer coating comprising an aqueous mixture of amorphous polyvinyl alcohol, an adhesion promoter comprising one or more of polyethylene and polyurethane, a crosslinker, and optionally, a catalyst.

Various amounts are contemplated for the components of the primer coating. In some embodiments of the present disclosure, when in aqueous solution, the primer coating may comprise from 3 weight percent (wt %) to 25 wt % amorphous polyvinyl alcohol (PVOH), from 0.05 wt % to 3 wt % of an adhesion promoter, such as polyethyleneimine (PEI), polyurethane (PU), or both, from 0.3 wt % to 5 wt % crosslinker, and optionally, may comprise a catalyst, with the remainder percentage comprising water (e.g., deionized water). In other embodiments, the primer coating in aqueous solution may comprise from 3 wt % to 15 wt % amorphous PVOH, from 0.15 wt % to 2 wt % adhesion promoter, from 0.5 wt % to 3 wt % crosslinker and optionally, may comprise a catalyst, with the remainder percentage comprising water. In accordance with some embodiments, the water may be substantially evaporated (with only a few parts per million of water present from absorption in ambient air) and the dried primer coating may comprise from about 30 wt % to 96.5 wt % amorphous PVOH, from about 0.5 wt % to 30 wt % adhesion promoter and 3 wt % to 50 wt % crosslinker. The dry film may also comprise a few parts per million of the optional catalyst.

In some embodiments, the primer coating comprises amorphous PVOH, which, unlike crystalline PVOH and semi-crystalline PVOH, does not have an ordered arrangement of molecules. The term “amorphous,” as used herein, refers to polymers that do not have a substantially ordered structure or arrangement of molecules, in contrast to crystalline or semi-crystalline polymers, which exhibit a substantially ordered, or a substantially semi-ordered structure or arrangements of molecules. Typically, increased crystallinity of a compound increases the material strength, which improves the barrier properties of the polymer. However, the unexpected results produced by the present embodiments display improved barrier properties, even over crystalline or semi-crystalline PVOH. As used herein, the term “semi-crystalline” refers to polymers which may have both crystalline regions and amorphous regions.

The crystallinity of a polymer can be measured through differential scanning calorimetry (DSC), which measures the thermal transitions of a polymer such as the glass transition temperature and crystallization temperature. In a DSC graph, as discussed above, the first incline typically depicts the glass transition temperature (T_{g}) of a polymer, followed by trough (a large decline in heat flow) when the polymer reaches its crystallization temperature (T_{c}), followed by a final peak when the polymer reaches its melting temperature. Most completely amorphous polymers will not have obvious crystallization troughs or melting temperature peaks. The term “peak,” as used herein, refers to an uptrend or downtrend of data on a graph, such as a spike or a trough.

A suitable amorphous polyvinyl alcohol for use in the primer coating is commercially available from Nippon Gohsei under the designation G-polymer™ OKS-8049 or AZF-8035W. OKS-8049 has a melting point of 185° C. and a viscosity of 4.5 millipascal seconds (mPa.s) at 4% aqueous solution at 20° C., and AZF8035W has a melting point of 171° C. and a viscosity of 3.0 mPa.s at 4% aqueous solution at 20° C. In some embodiments, the amorphous PVOH may have a melting point range of 160° C. to 200° C.

The adhesion promoter may comprise one or more of polyethylene and polyurethane. Without being bound by theory, the polyethyleneimine or polyurethane may act as an adhesion promoter to achieve good adhesion of the coating to a polymeric substrate. In some embodiments the adhesion promoter comprises polyethylene. A commercial embodiment of a suitable polyethyleneimine is Lupasol P from BASF. Other suitable commercial embodiments of polyethyleneimine include Polymin P, available from BASF, Epomin, available from Nippon Shokubai, TITA Bond T100, available from Nippon Soda Co., and D1 Dry AC-108, available from DIC Graphics. In other embodiments the adhesion promoter comprises polyurethane. The polyurethane may be used as an alternative to or in addition to polyethyleneimine. Commercial embodiments of suitable polyurethane include 86A from 3M, Syntegra from Dow Chemical, Desmophen from Bayer AG and Loctite 3951 from Loctite.

In some embodiments of the present disclosure, the crosslinker may comprise an aldehyde, dialdehyde, organic salt, inorganic salt, or a combination thereof. The crosslinker may, in some embodiments, comprise melamine formaldehyde. In other embodiments, the crosslinker may comprise urea formaldehyde, glyoxal, glutaraldehyde, zirconium oxide, zinc oxide, titanium lactate, or any other crosslinking agents that interconnects and crosslinks the PVOH molecules as the primer coating dries. Without being bound by theory, crosslinkers are beneficial in the present coatings, as amorphous polyvinyl alcohol that is crosslinked exhibits better barrier characteristics than PVOH that is not crosslinked. PVOH is soluble in water and can be susceptible to attack by moisture, making it is desirable to crosslink the PVOH to provide an improved barrier to increase the oxygen transmission rating (OTR) and to also to provide better lamination strength and resistance to delamination in humid environments.

Suitable commercial embodiments of a crosslinker include Cymel 385 resin, produced by Allnex (Brussels, Belgium) and Aerotex 3030, Aerotex 3730, or Aerotex M3, produced by Emerald Performance Materials (Charlotte, N.C.). Other suitable commercial embodiments of a crosslinker include Beetle PT312 Resin from BIP Company (Oldbury, UK), as well as many other suitable cymel grade crosslinkers.

As stated above, the primer coating may optionally comprise a catalyst. It can be difficult for the crosslinker to fully crosslink throughout a layer of polyvinyl alcohol; therefore, a crosslinking-promoting catalyst may be desirable. The optional catalyst may, in some embodiments, be an organic or inorganic acid catalyst, or a salt of an organic or inorganic acid catalyst. The amount of optional catalyst used may, in some embodiments, be a quantity needed to get the pH of the primer coating solution between 2 and 6. In some embodiments, the optional acid catalyst will cause the primer coating solution to have a pH between 2 and 7 or between 2 and 6. The optional acid catalyst may cause the solution to have a pH of 3.5 or less, or a pH of 3 or less. In some embodiments, the amount of catalyst may be between 0.1 wt % and 3 wt % of the primer coating when in aqueous solution. In other embodiments, the amount of catalyst used may be between 0.1 wt % and 1.5 wt % of the primer coating when in aqueous solution. The amount of catalyst used may be between 0.1 wt % and 1.0 wt %, or from 0.5 wt % to 1.5 wt %, or from 0.5 wt % to 1.0 wt %, or 0.1 wt % to 2.0 wt % of the primer coating when in aqueous solution. The amount of catalyst may, in some embodiments, be from 0.6 wt % to 0.8 wt %, or from 0.6 wt % to 0.9 wt %, or from 0.65 wt % to 0.75 wt % of the primer coating when in aqueous solution.

The optional catalyst may, in some embodiments, be an orthophosphate catalyst. In other embodiments, the optional catalyst may be citric acid, hydrochloric acid, phosphoric acid, nitric acid, maleic acid, lactic acid, acetic acid or paratoluene sulfonic acid. In some embodiments, one or more catalysts may be used. For example, in accordance with one or more embodiments, two catalysts may be used wherein the first acid catalyst may be selected from the group consisting of orthophosphoric acid, nitric acid, acetic acid, hydrochloric acid, and maleic acid and the second acid catalyst may be selected from the group consisting of citric acid, maleic acid, acetic acid, paratoluene sulfonic acid and lactic acid. Some acid catalysts may be particularly desirable if the primer coating is to be used in the food packaging industry, as certain acid catalysts (such as phosphoric acids and citric acids) are generally recognized as safe for use, or “GRAS” products.

In some embodiments, the primer coating may include one or more additives. The primer coating may include, for instance, preservatives, primers, additional crosslinkers, additional catalysts, and the like. In some embodiments, the primer coating may include a water based primer, such as Michem® Flex P2300 (commercially available from Michelman, Inc., Cincinnati, Ohio). In some embodiments, the primer coating may include a preservative, such as Biocide Proxel® GXL (20% active) (commercially available from Arch Chemicals, Norwalk CT) or formaldehyde.

In some embodiments of the present disclosure, the primer coating may exhibit a glass transition temperature (T_{g}) of 80° C. to 100° C. when measured according to DSC. In other embodiments, the primer coating may exhibit a T_{g} of 95° C. to 100° C., or 97° C. to 98° C. when measured according to DSC. In some embodiments, the primer coating may exhibit an increased T_{g} of 10° C. when compared to similar primer coatings that do not contain a crosslinker. In other embodiments, the primer coating may exhibit an increased T_{g} of 5° C. to 8° C., or 12° C. to 15° C., or greater than 20° C., when compared to similar primer coatings that do not contain a crosslinker. Without being bound by theory, the crosslinker may increase the molecular weight of the coating, increasing the rigidity and thus causing the polymer to become more brittle.

In accordance with one or more embodiments, the primer coating may exhibit no obvious crystalline peaks above 100° C. when measured according to DSC. As discussed above, it should be understood that the term “peak” may refer to a substantial change in terms of heat flow as measured by DSC, which may be depicted as a trough on the DSC graphs.

Another method of measuring the crystallinity of a compound is to use attenuated total reflectance Fourier transform infrared spectroscopy (ATR FTIR), which determines the infrared spectrum of absorption, emission, and the photoconductivity of a compound. As discussed in Tretinnikov, 0. N., et al., “Detection and Quantitative Determination of the Crystalline Phase in Poly(vinyl Alcohol) Cryogels by ATR FTIR Spectroscopy.” Polym. Sci. Ser. A Polymer Science Series A 55.2 (2013): 91-97, the crystallinity of the primer coating can be determined by analyzing ATR FTIR spectroscopy absorbance bands. In one or more embodiments of the present disclosure, the primer coating may exhibit an ATR FTIR absorbance of from 0.00 to 0.019 at 1133 cm⁻¹ and from 0.00 to 0.072 at 1094 cm⁻¹. In some embodiments, the primer coating may exhibit an ATR FTIR absorbance of from 0.00 to 0.005 or from 0.00 to 0.0035, or from 0.00 to 0.020 at 1133 cm⁻¹. In other embodiments, the primer coating may exhibit an ATR FTIR absorbance of from 0.00 to 0.075, or from 0.00 to 0.020, or from 0.00 to 0.015 at 1094 cm⁻¹. The primer coating may exhibit a % crystallinity of less than 10-15% crystallinity when calculated according to ATR FTIR, referenced above. The primer coating may have a % crystallinity of less than 15%, or less than 12%, or less than 10%, or less than 5%, or less than 3% crystallinity.

According to one or more embodiments of the present disclosure, the primer coating may have a viscosity below 200 centipoises (cP) when measured using a Brookfield LV-series viscometer (commercially available from Brookfield Engineering™) with spindle 1 at 60 rotations per minute (RPM) as per industry standards, at a temperature of about 23° C. In other embodiments, the primer coating may have a viscosity below 150 cP, or below 100 cP, or below 75 cP, or below 50 cP, or below 25 cP, when measured using a Brookfield LV-series viscometer (commercially available from Brookfield Engineering™) with spindle 1 at 60 RPM.

Another embodiment of the present disclosure includes, among other things, a coated polymeric substrate which comprises a polymeric substrate and a coating dispersed over the polymeric substrate comprising amorphous PVOH, an adhesion promoter comprising one or more of polyethyleneimine and polyurethane, and a crosslinker.

Suitable polymeric substrates include polylactic acid (PLA), polyethylene terepthalate (PET), biaxially oriented polyethylene terepthalate (BOPET), oriented polypropylene (OPP), biaxially oriented polypropylene (BOPP), and biaxially oriented polyamide (BOPA). Typically, for food packaging applications, the polymer films will range in thickness from about 10 to about 100 μm.

In another embodiment of the present disclosure, a method of making a coated polymeric substrate comprises, among other steps, stretching the polymeric substrate, applying a coating to at least one surface of the stretched polymeric substrate, and curing the coating onto at least one surface of the stretched polymeric substrate.

The coating may be prepared by adding the components to a mixing vessel and mixing, for example, at ambient temperatures until all of the components are adequately blended. The coating may, in some embodiments, be applied to one or both sides of the substrate. The coating may be applied by gravure coating, rod coating, or flexographic printing at ambient temperature to polymeric substrates. Prior to applying the coating, a corona discharge pre-treatment may be used on the substrate to ensure that the coating will wet out the surface of the film and achieve adequate coverage. Alternatively, in some embodiments, prior to applying the coating a pre-treatment of a flame or plasma treatment may be used. This treatment may be applied either in-line or off-line.

As referred to herein, the term “off-line” is used to refer to a polymeric substrate that is coated and dried before being stretched or oriented. As referred to herein, the term “in-line” is used to refer to a polymeric substrate wherein the substrate is stretched at least once prior to being coated. In some embodiments, raising the temperature of the substrate through stretching at least once in one or more directions and then coating the substrate with the primer coating may further promote curing and crosslinking.

In some embodiments, stretching may be accomplished by heating the film to a molten state followed by stretching in a machine direction orientation (MDO), followed by stretching in the transverse direction orientation (TDO) 90 degrees from machine direction, followed by a quenching of the polymeric substrate. In some embodiments, the polymeric substrate is MDO stretched, TDO stretched, or both. The polymeric substrate may, in some embodiments, be stretched in a MDO direction and then subsequently stretched in a TDO direction, or may be heated and then stretched in both directions (MDO and TDO) simultaneously. Additionally, there may be steps in between the stretching processes, such that the polymeric substrate may, in some embodiments, be MDO stretched, then dried, and then TDO stretched. Similarly, the polymeric substrate may, in some embodiments, be MDO stretched, coated, and then TDO stretched, or vice versa. The substrate may also be heated again after being stretched in one direction to further facilitate crosslinking.

In accordance with one or more embodiments, the coating may be cured at a temperature of 120° C. to 240° C. In some embodiments, the coating may be cured at a temperature of 180° C. to 220° C., or 120° C. to 160° C. In other embodiments, the coating may be cured at a temperature of 190° C. to 210° C., or 195° C. to 215° C., or 130° C. to 150° C.

The coated polymeric substrate may, in some embodiments, may further comprise a vacuum-deposited metallized coating or metal oxide. The metallized coating or metal oxide may, in some embodiments, comprise aluminum, or another metal or metal oxide coating which provides suitable barrier properties. The optical density of the metallized coating or metal oxide may, in some embodiments, be from 2.0 to 2.7. In further embodiments, the optical density of the metallized coating or metal oxide may be from 1.5 to 4.0. In some embodiments, the optical density of the metallized coating or metal oxide may be 2.0, or 2.3, or 2.5, or 2.7, or 3.0, or 3.5, or 1.5, or 4.0.

In some embodiments, the coated polymeric substrate further comprising a metallized coating or metal oxide may provide an increased barrier and may increase the OTR. In some embodiments, the coated polymeric substrate may have a metal adhesion bond strength to the metallized coating of greater than or equal to 300 g/in when measured using ethylene acrylic acid (EAA) film at 105° C. for 20 seconds according to TP-105-92, a metal adhesion test published by the Association for Metalizers, Coaters, and Laminators (AIMCAL). In other embodiments, the coated polymeric substrate may have a metal adhesion bond strength of greater than or equal to 200 g/in, or greater than or equal to 250 g/in, or greater than or equal to 350 g/in, or greater than or equal to 400 g/in.

The coated polymeric substrate, in some embodiments, may exhibit advantageous barrier properties, such as an increased OTR. It is well-known that use of a metallization coating, PVOH, or a combination of the two together, can improve barrier properties. However, the coated polymeric substrate of the present disclosure utilizes a unique primer coating comprising amorphous PVOH and a crosslinker to further improve the barrier properties and OTR. Without being bound by theory, the crosslinking of the amorphous PVOH unexpectedly increases the barrier properties of the coated polymeric substrate. Moreover, utilizing the coated polymeric substrate with a metallized coating increases the barrier properties and OTR of the substrate even further. In some embodiments, a 50 μm coated polymeric substrate comprising a metallization coating may exhibit an improved OTR of less than or equal to 1.00 cc/m²/atm when measured according to ASTM D3985 at 23° C. with 0% relative humidity. In other embodiments, the 50 μm coated polymeric substrate comprising a metallization coating may exhibit an improved OTR of less than or equal to 0.80 cc/m²/atm, or less than or equal to 0.70 cc/m²/atm, or less than or equal to 0.65 cc/m²/atm. In other embodiments, the 50 μm coated polymeric substrate comprising a metallization coating may exhibit an improved OTR or less than or equal to 0.55 cc/m²/atm or less than or equal to 0.50 cc/m²/atm, when measured at 23° C. with 0% relative humidity. In some embodiments, similar OTR results may be achieved using a substrate with a thickness of up to 75 μm, or up to 60 μm, or up to 40 μm, or up to 30 μm.

### EXAMPLES

In order that the embodiments may be more easily understood, reference is made to the following examples which are intended to illustrate embodiments disclosed and described herein. The examples are in no ways limiting in scope.

Primer coatings were prepared in accordance with an embodiment of the disclosure using the following formulation:

### Example 1

| Component | Weight % of total compound |
|---|---|
| Deionized water | 87.67% |
| Amorphous PVOH¹ | 8.62% |
| Polyethyleneimine² | 0.94% |
| Crosslinker³ | 1.8% |
| Catalyst⁴ | 0.7% |
| Formaldehyde (37% active) | 0.19% |
| Preservative⁵ | 0.08% |

¹G-polymer ™ AZF8035W from Soarus LLC (95% active)
²LOXANOL MI6730 (50% active)
³Cymel 385 (79% active)
⁴Orthophosporic acid (85% active)
⁵Biocide Proxel GXL (20% active) from Arch Chemicals

### Comparative Example 1

| Component | Weight % of total compound |
|---|---|
| Deionized water | 89.3 |
| Amorphous PVOH¹ | 10.5 |
| 50% polyethyleneimine⁶ | 0.1 |
| Preservative⁵ | 0.1 |

⁶Lupasol ® P from BASF

### Comparative Example 2

| Component | Weight % of total compound |
|---|---|
| Deionized water | 91.6 |
| Semicrystalline PVOH⁷ | 8.2 |
| Preservative⁵ | 0.2 |

⁷Elvanol ® 90-50 from DuPont

The samples were prepared as follows. Example 1 was prepared by loading deionized water and PVOH and mixing the composition until dissolved. PEI was mixed with formaldeyhde and the PEI/formaldehyde mixture was added to the PVOH solution under mixing conditions. Next, the crosslinker and then the catalyst were added to the composition. Finally, the preservative was added to the composition. Comparative Example 1 was prepared by adding water and PVOH and mixing the composition until dissolved. PEI was mixed with a preservative and the PEI/preservative mixture was added to the PVOH solution while mixing. Comparative Example 2 was prepared by adding water and PVOH and mixing the composition while heating the composition to 90° C. until the PVOH is dissolved. The composition was cooled and preservative was added to the composition.

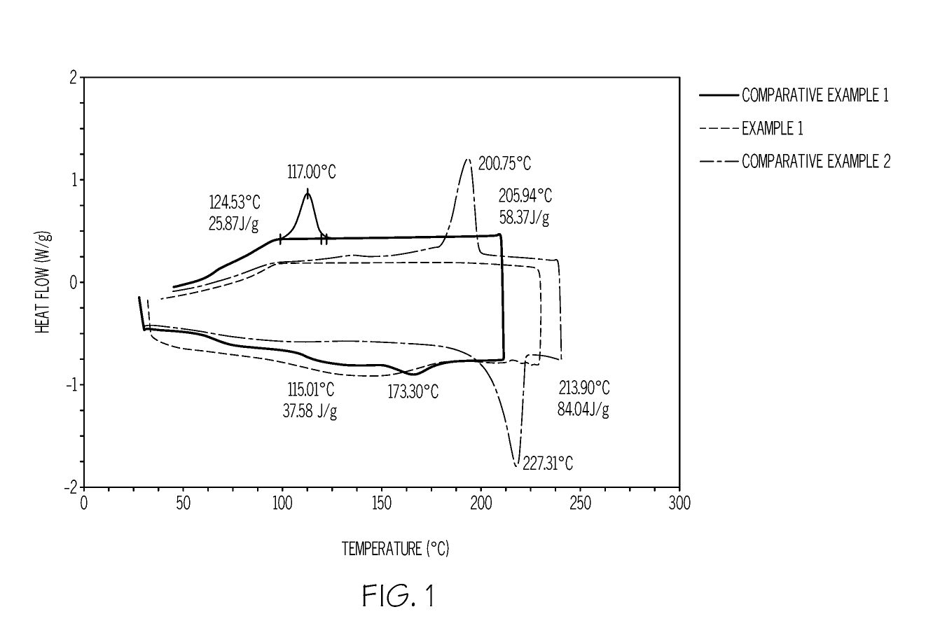

Referring now to the figures, FIG. 1 is a graph of differential scanning calorimetry (DSC) data (technique previously discussed), measuring temperature (° C.) and heat flow (W/g) to show the crystalline peaks and glass transition peaks of examples according to embodiments disclosed and described herein and two comparative examples. FIG. 1 shows that the Example 1, (formulation discussed above which includes amorphous PVOH and a crosslinker), does not exhibit peaks above 100° C. with only a slight peak around 97.4° C. indicative of the glass transition temperature. Comparing Example 1, which includes amorphous PVOH and crosslinker, to Comparative Example 2, which comprises semi-crystalline PVOH and no crosslinker, the DSC peaks greatly differ. Specifically, Comparative Example 2 exhibits peaks at 200.75° C. and 227.31° C. which are indicative of its semi-crystalline structure. Thus, there is a clear distinction between semi-crystalline and amorphous PVOH primer coating formulations.

When comparing the Comparative Example 1, (containing amorphous PVOH and no crosslinker,) to Example 1, it is further illustrated that the crosslinker also changes the crystallinity of the primer coating such that there are no crystalline peaks above 100° C. In contrast, Comparative Example 1, which does not comprise a crosslinker, exhibits peaks at 117.00° C. and again at 173.30° C. Thus, the crosslinker changes the crystallinity of the primer coating, which is fully crosslinked and acting as a thermoset polymer, as demonstrated in FIG. 1.

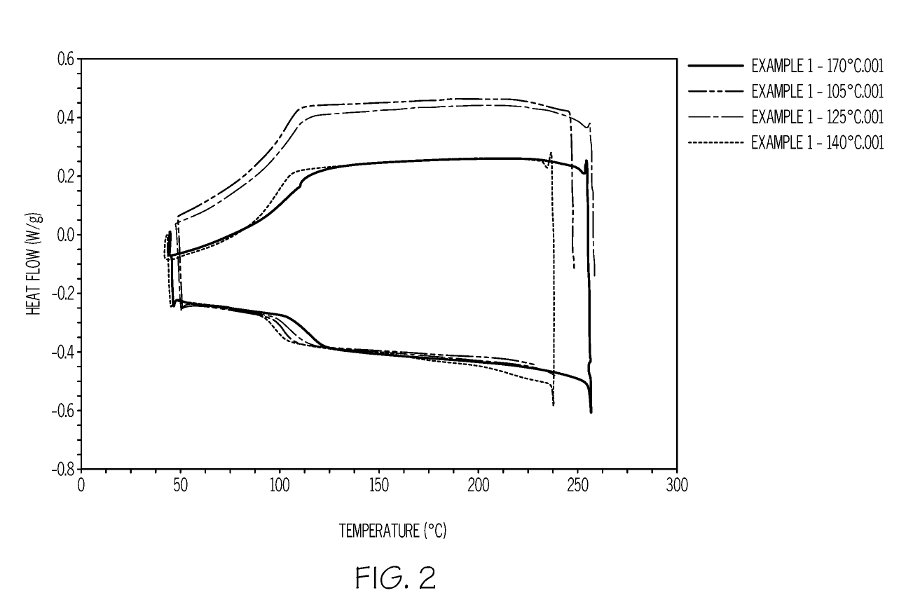

FIG. 2 is another graph of DSC data, measuring temperature (° C.) and heat flow (W/g) to show the crystalline peaks and glass transition peaks of Example 1. As previously mentioned in regards to FIG. 1, Example 1 does not exhibit any peaks above 100° C. with only a slight peak around 97° C. indicative of the glass transition temperature. FIG. 2 depicts a heating cycle of Example 1. As seen in FIG. 2, at 105° C., 125° C., 140° C., and 170° C. Example 1 does not exhibit any peaks above 100° C. Even at varying temperature conditions from 105° C. and up to 170° C., Example 1 does not exhibit any large, sharp crystallization peaks above 100° C. FIG. 2 illustrates the unique and novel properties exhibited by Example 1 which, without being bound by theory, may be due in part to the crosslinker and the amorphous PVOH present in the primer coating.

Referring now to the Tables, Table 1 depicts the crystallinity properties of Example 1 compared to Comparative Examples 1 and 2 based on the FTIR ATR absorbance and percent crystallinity. As shown in Table 1, Example 1 has a much lower FTIR ATR absorbance at 1144 cm⁻¹ and 1094 cm⁻¹ and therefore a much low percent crystallinity than Comparative Examples 1 and 2. Example 1 has between 10 to 11% crystallinity at 105° C., in contrast to Comparative Example 1, which has between 24 to 29% crystallinity at 105° C. and Comparative Example 2 which has between 24 to 44% crystallinity at 105° C. Furthermore, Example 1 exhibits an even lower percent crystallinity at 170° C., at only 2.3% crystallinity. This is contrasted with the crystallinity of Comparative Examples 1 and 2 at 170° C., which have 17.1% crystallinity and 40.4% crystallinity, respectively.

Table 1 shows absorbance utilizing two different FTIR ATR techniques, transmission on crystal and in an aluminum cup. For the transmission on crystal, one drop of the dispersion was cast onto a ZnSe crystal and dried in an oven for a few minutes at 105° C. to evaporate out water. The FTIR spectra were obtained by the response from the IR lamp through the coated crystal, as the ZnSe crystal does not interfere with the vibration of the organic molecules. For the aluminum cup technique, the product was filled in an aluminum cup at 105° C. for 2 hours to evaporate out water. The dry residue was then put in contact with germanium crystal and a spectrum from the surface of the sample was obtained.

Table 1 shows that Example 1, and thus the embodiments disclosed herein, exhibit a much lower FTIR ATR absorbance at 1144 cm⁻¹ and 1094 cm⁻¹ as well as a lower percent crystallinity when compared to a substrate comprising an uncrosslinked amorphous PVOH primer (such as Comparative Example 1) and a substrate comprising an uncrosslinked semi-crystalline PVOH (such as Comparative Example 2). Without being bound by theory, the crosslinking amorphous PVOH present in the primer coating of the present disclosure reduces percent crystallinity and FTIR ATR absorbance at 1144 cm⁻¹ and 1094 cm⁻¹.

TABLE 1
Crystallinity Properties

| | FTIR ATR Absorbance | | | |
|---|---|---|---|---|
| | 1144 | 1094 | | % Crystal- |
| Product Tested | cm⁻¹ | cm⁻¹ | Ratio | linity |
| Example 1 | 0.019 | 0.072 | 0.26 | 10.5 |
| Transmission on crystal at | | | | |
| 105° C. | | | | |
| Example 1 | 0.0048 | 0.0178 | 0.27 | 11.0 |
| in Al cup 105° C./2 h | | | | |
| Example 1 | 0.0031 | 0.018 | 0.17 | 2.3 |
| in Al cup 170° C./2 h | | | | |
| Comparative Example 1 | 0.082 | 0.176 | 0.47 | 28.6 |
| Transmission on crystal at | | | | |
| 105° C. | | | | |
| Comparative Example 1 | 0.0095 | 0.0227 | 0.42 | 24.4 |
| in Al cup 105° C./2 h | | | | |
| Comparative Example 1 | 0.005 | 0.0148 | 0.34 | 17.1 |
| in Al cup 170° C./2 h | | | | |
| Comparative Example 2 | 0.0093 | 0.0147 | 0.63 | 43.5 |
| Transmission on crystal at | | | | |
| 105° C. | | | | |
| Comparative Example 2 | 0.0037 | 0.0088 | 0.42 | 24.5 |
| in Al cup 105° C./2 h | | | | |
| Comparative Example 2 | 0.0128 | 0.0214 | 0.60 | 40.4 |
| in Al cup 170° C./2 h | | | | |

Referring now to Table 2, the barrier and adhesion properties were also tested for Example 1 (composition described above) and a Comparative Example to show the affect of in-line versus off-line stretching on oxygen transmission rating (OTR) and metal adhesion strength.

TABLE 2
Barrier and Adhesion Properties

| | OTR | | Metal Adhesion |
|---|---|---|---|
| Product | (cc/m²/atm at 23° C.) | | (g/in) (EAA film, |
| Tested | 0% RH | 90% RH | 105° C., 1, 23b, 20s) |
| Example 1 off-line | 0.24 | 36.3 | Not Tested |
| Example 1 in-line | 0.08 | 0.04 | >300 |
| Comparative | 0.5 | 0.6 | 40 |
| Example (no | | | |
| primer) | | | |

In Table 2, the OTR and metal adhesion was tested for Example 1, a coated polymeric substrate according to embodiments described herein, in in-line and off-line applications (stretching the substrate before or after coating, as previously discussed) as well as a Comparative Example, which does not comprise a primer coating. The first example, “Example 1 off-line,” tested 28 microns of BOPET in an off-line application, meaning that the substrate was coated with 0.5 grams per square meter (gsm) of a primer coating according to the embodiments described herein and then dried prior to any stretching. The polymeric substrate further comprised a 2.7 OD aluminum metallization coating vacuum-deposited onto the substrate. The second example, “Example 1 in-line,” tested 12 microns of BOPET, stretched in a machine direction orientation and then coated with 0.07 gsm of a primer coating according to embodiments described herein. A 2.7 OD aluminum metallization coating was again vacuum-deposited onto the polymeric substrate. Finally, “Comparative Example” tested 12 microns of BOPET with a vacuum-deposited 2.7 OD aluminum metallization coating. The Comparative Example did not contain a primer coating. The oxygen transmission rating and metal adhesion strength was calculated for each.

The OTR testing was conducted with a OX-TRAN® 2/22 oxygen permeation instrument (commercially available from Mocon located in Minnesota, Minn.), according to ASTM D3985 at 23° C. with 0% relative humidity and again at 90% relative humidity. The metal adhesion was tested using ethylene acrylic acid (EAA) film with a heat sealer at 105° C., 1.23b for 20 seconds. The metal adhesion was measured using a EJA series tensile tester from Thwing-Albert Instrument Company.

As shown in Table 2, the use of the primer coating according to embodiments described herein greatly increases the metal adhesion over the non-primed Comparative Example from 40 g/in to over 300 g/in, which is an increase in metal adhesion of 750%. Furthermore, use of the primer coating in in-line applications may unexpectedly increase the metal adhesion strength even more when the primer coating is applied after stretching (i.e., in-line) as compared to coatings applied before stretching (i.e., off-line). Without being bound by theory, stretching the polymeric substrate at least once before applying the primer coating described herein may raise the temperature of the polymeric substrate to promote crosslinking and curing, which may increase the metal adhesion strength.

Moreover, use of the primer coating according to embodiments described herein also advantageously increases the OTR over the non-primed Comparative Example. Similarly to metal adhesion strength, the in-line application of Example 1 shows an even further improvement over the off-line application of Example 1. “Example 1 in-line,” which was stretched prior to coating, exhibited the lowest OTR at 0.08 cc/m²/atm with 0% relative humidity (RH) and 0.04 cc/m²/atm with 90% RH. As OTR is a measurement of the amount of oxygen that passes through the barrier of the substrate, it is desirable to have the lowest oxygen transmission rate, or OTR. Both the in-line and off-line applications of Example 1 showed improved OTR when compared to the Comparative Example, with an OTR of 0.5 cc/m²/atm at 0% RH and 0.6 cc/m²/atm at 0% RH. Additionally, the in-line application of Example 1 experienced an even more desirable OTR, at 0.08 cc/m²/atm at 0% RH and 0.04 cc/m²/atm at 90% RH, compared to the non-primed Comparative Example, which had an OTR of 0.5 cc/m²/atm at 0% RH and 0.6 cc/m²/atm at 90% RH. This demonstrates that use of the primer coating in in-line applications may increase the oxygen transmission rating even more when the primer coating is applied after stretching (i.e., in-line) as compared to coatings applied before stretching (i.e., off-line). Even seemingly minimal improvements in OTR may significantly impact the shelf-life of food items and are considered quite advantageous.

To compare the differences between the amorphous PVOH used in the present disclosure with conventional crystalline PVOH, the pH and viscosity of three different compositions, a comparative example Comparative Example 3, and two examples in accordance with the present embodiments, Example 3, and Example 4 were studied. Table 3 shows the compositions for Comparative Example 3, containing semi-crystalline PVOH with orthophosphoric acid (H₃PO₄), polyethyleneimine and crosslinker. Five different samples of the composition were formulated, each having varying amounts of the optional acid catalyst, H₃PO₄.

TABLE 3
Compositions of Five Samples of Comparative Example 3

| | Commercial | | | | | |
|---|---|---|---|---|---|---|
| | Name | Sample | | | | |
| Component (wt %) | and Supplier | 1 | 2 | 3 | 4 | 5 |
| Deionized Water | — | 83.96 | 83.82 | 83.68 | 83.53 | 83.39 |
| Semi-crystalline | Elvanol ® | 7 | 7 | 7 | 7 | 7 |
| PVOH | 90-50 from | | | | | |
| | DuPont | | | | | |
| Polyethyleneimine | Polymin ® | 0.06 | 0.06 | 0.06 | 0.06 | 0.06 |
| | P from BASF | | | | | |
| | Chemicals | | | | | |
| Preservative | Biocide | 0.13 | 0.13 | 0.13 | 0.13 | 0.13 |
| | Proxel ® | | | | | |
| | GXL (20% | | | | | |
| | active) from | | | | | |
| | Arch | | | | | |
| | Chemicals | | | | | |
| Primer | Michem ® | 7.39 | 7.39 | 7.39 | 7.39 | 7.39 |
| | Flex P2300 | | | | | |
| | from | | | | | |
| | Michelman Inc. | | | | | |
| H₃PO₄ | — | 0 | 0.14 | 0.28 | 0.43 | 0.57 |
| Crosslinker | Cymel ® | 1.46 | 1.46 | 1.46 | 1.46 | 1.46 |
| | 385 (79% | | | | | |
| | active) from | | | | | |
| | Allnex | | | | | |

The pH and viscosity (in centipoises (cP)), was tested for each of the five samples of Comparative Example 3 over a time period of four weeks. A reading of “gel” indicates that the sample formed a gel that was too viscous to accurately measure. The results are shown below in Table 4.

TABLE 4
Comparative Example 3 - pH and Viscosity over Time

| | | Sample | Sample | Sample | Sample | Sample |
|---|---|---|---|---|---|---|
| Time Elapsed | | 1 | 2 | 3 | 4 | 5 |
| | | pH | | | | |
| Initial Reading | | 9.28 | 7.94 | 6.68 | 5.6 | 4.72 |
| 1 | day | 8.78 | 7.83 | 6.42 | 5.48 | 4.6 |
| 2 | days | 8.42 | 7.21 | 5.96 | 5.12 | 4.5 |
| 2 | weeks | 8.17 | 6.73 | 5.63 | 4.98 | 4.42 |
| 3 | weeks | 8.1 | 6.68 | 5.65 | 5.02 | 4.51 |
| 4 | weeks | 7.88 | 6.55 | 5.54 | 4.89 | 4.38 |
| | | Viscosity (cP) | | | | |
| 1 | day | 72.5 | 75 | 77.5 | 111 | gel |
| 2 | day | 77 | 78 | 92.5 | gel | gel |
| 2 | weeks | 86 | 82 | 222 | gel | gel |
| 3 | weeks | 80 | 86 | 286 | gel | gel |
| 4 | weeks | 81 | 86 | 295.5 | gel | gel |

Example 3 of the present disclosure contained amorphous PVOH, polyethyleneimine and crosslinker, and optionally, orthophosphoric acid as a catalyst (as Sample 1 did not contain H₃PO₄). Five samples were tested with varying amounts of the optional catalyst. The compositions of each sample are listed below in Table 5.

TABLE 5
Compositions of Five Samples of Example 3

| Component | Commercial Name | Sample | | | | |
|---|---|---|---|---|---|---|
| (wt %) | and Supplier | 1 | 2 | 3 | 4 | 5 |
| Deionized Water | — | 80.24 | 80.065 | 79.89 | 79.715 | 79.54 |
| Amorphous PVOH | G-polymer ™ | 8.62 | 8.62 | 8.62 | 8.62 | 8.62 |
| | AZF8035W from | | | | | |
| | Soarus LLC (95% | | | | | |
| | active) | | | | | |
| Polyethyleneimine | Polymin ® P from | 0.08 | 0.08 | 0.08 | 0.08 | 0.08 |
| | BASF Chemicals | | | | | |
| Preservative | Biocide Proxel ® GXL | 0.16 | 0.16 | 0.16 | 0.16 | 0.16 |
| | (20% active) from | | | | | |
| | Arch Chemicals | | | | | |
| Primer | Michem ® Flex P2300 | 9.1 | 9.1 | 9.1 | 9.1 | 9.1 |
| | from Michelman Inc. | | | | | |
| H₃PO₄ | — | 0 | 0.175 | 0.35 | 0.525 | 0.7 |
| Crosslinker | Cymel ® 385 (79% | 1.8 | 1.8 | 1.8 | 1.8 | 1.8 |
| | active) from Allnex | | | | | |

The pH and viscosity (in cP), was tested for each of the five samples of Example 3. Example 3 was tested over a time period of five weeks. Notably, even after 5 weeks, none of samples 1 to 5 of Example 3 gelled. The results are shown below in Table 6.

TABLE 6
Example 3 - pH and Viscosity over Time

| | | Sample | Sample | Sample | Sample | Sample |
|---|---|---|---|---|---|---|
| Time Elapsed | | 1 | 2 | 3 | 4 | 5 |
| | | pH | | | | |
| 1 | day | 8.92 | 7.24 | 6.05 | 5.04 | 4.28 |
| 3 | days | 8.5 | 7 | 5.57 | 4.68 | 4.08 |
| 1 | week | 8.12 | 6.51 | 5.43 | 4.68 | 4.07 |
| 2 | weeks | 7.52 | 6.14 | 5.04 | 4.38 | 3.81 |
| 5 | weeks | 7.3 | 5.97 | 4.97 | 4.32 | 3.72 |
| | | Viscosity (cP) | | | | |
| 1 | day | 10 | 10 | 10 | 13 | 19 |
| 3 | day | 10 | 10 | 12 | 14 | 20 |
| 1 | week | 10 | 10 | 12 | 14 | 20 |
| 2 | weeks | 15 | 14.5 | 15 | 17 | 20.5 |
| 5 | weeks | 14 | 15.5 | 14 | 15.5 | 17.5 |

Similarly, the pH and viscosity were both measured for Example 4. Example 4 contained amorphous PVOH, polyethyleneimine and crosslinker, and acetic acid (CH₃COOH) as a catalyst. The compositions of each sample are listed below in Table 7.

TABLE 7
Compositions of Four Samples of Example 4

| Component | Commercial Name | Sample | | | |
|---|---|---|---|---|---|
| (wt %) | and Supplier | 1 | 2 | 3 | 4 |
| Deionized | — | 80.065 | 79.89 | 79.715 | 79.54 |
| Water | | | | | |
| Amorphous | G-polymer ™ | 8.62 | 8.62 | 8.62 | 8.62 |
| PVOH | AZF8035W from | | | | |
| | Soarus LLC (95% | | | | |
| | active) | | | | |
| Polyethyl- | Polymin ® P from | 0.08 | 0.08 | 0.08 | 0.08 |
| eneimine | BASF Chemicals | | | | |
| Preservative | Biocide Proxel ® | 0.16 | 0.16 | 0.16 | 0.16 |
| | GXL (20% active) | | | | |
| | from Arch Chemicals | | | | |
| Primer | Michem ® Flex | 9.1 | 9.1 | 9.1 | 9.1 |
| | P2300 from | | | | |
| | Michelman Inc. | | | | |
| CH₃COOH | — | 0.175 | 0.35 | 0.525 | 0.7 |
| Crosslinker | Cymel ® 385 (79% | 1.8 | 1.8 | 1.8 | 1.8 |
| | active) from Allnex | | | | |

The pH and viscosity (in cP), was tested for each of the four samples of Example 4 over a time period of four weeks. Notably, like Example 3, all of samples 1 to 5 of Example 4 did not gel. The results are shown below in Table 8.

TABLE 8
Example 4 - pH and Viscosity over Time

| Time Elapsed | | Sample 1 | Sample 2 | Sample 3 | Sample 4 |
|---|---|---|---|---|---|
| | | pH | | | |
| 1 | day | 6.65 | 5.48 | 4.96 | 4.4 |
| 3 | days | 5.83 | 5.02 | 4.68 | 4.29 |
| 1 | week | 5.56 | 4.96 | 4.65 | 4.29 |
| 2 | weeks | 5.53 | 4.99 | 4.63 | 4.27 |
| 4 | weeks | 5.37 | 4.88 | 4.58 | 4.21 |
| | | Viscosity (cP) | | | |
| 1 | day | 12 | 10 | 28 | 18 |
| 3 | day | 10 | 16 | 22 | 18 |
| 1 | week | 16 | 19.5 | 23.5 | 22.5 |
| 2 | weeks | 21.5 | 17.5 | 22.5 | 20 |
| 4 | weeks | 15 | 14 | 18 | 19 |

Tables 4, 6, and 8 show that Examples 3 and 4 of the present disclosure show a much more stable viscosity as compared to Comparative Example 3. For example, Comparative Example 3 Sample 3 after one day had a pH of 6.42 and a viscosity of 77.5 cP. After 3 days, the viscosity jumped to 92.5 cP, and after 2 weeks the viscosity was up to 222 cP. By the end of 4 weeks, Comparative Example 3 Sample 3 had a viscosity of 295.5 cP (almost gelled). In comparison, Example 3 Sample 3 had a pH after one day of 6.05 and a viscosity of 10 cP. After 3 days, the viscosity only increased to 12 cP, and to 15 cP after 2 weeks. By the end of 5 weeks, the viscosity was still only at 14 cP. Thus, over a longer time period of 5 weeks, Example 3 Sample 3 showed a change in viscosity of 4 cP compared to Comparative Example 3 Sample 3, which showed a change in viscosity over only 4 weeks of 218 cP.

Demonstrating that the results are directly contributed to the unique combination of amorphous polyvinyl alcohol, polyethyleneimine or polyurethane as an adhesion promoter, and crosslinker, as recited by the present disclosure, Example 3 Sample 1 did not contain any orthophosphoric acid and still showed a stabilized viscosity of 10 cP after 1 day, 10 cP viscosity after 1 week, and only 14 cP after 5 weeks. Similarly, while orthophosphoric acid is a strong mineral inorganic acid, Example 4 utilized acetic acid, a much weaker organic acid, and still achieved similar stabilized viscosity results. For instance, Example 4 Sample 1 had a pH after 1 day of 6.65 and a viscosity of 12 cP, which increased only to 16 cP after 1 week and after 14 weeks was measured at only 15 cP.

Examples 3 and 4 of the present disclosure showed slight, incremental increases in viscosity over a time period of up to 5 weeks (5 cP or less with a viscosity of less than 20 cP after 4 weeks), as compared to Comparative Example 3, which exhibited a very high viscosity (Comparative Example 3 Samples 1 and 2 had a viscosity after only 1 day of 72.5 cP and 75 cP, respectively), with drastic increases (Comparative Example 3 Sample 3 had a net increase in viscosity of 218 cP) and gelled formations (Comparative Example Samples 4 and 4 gelled after 3 days and after only 1 day, respectively). Examples 4 and 5 showed superior viscosity control over a time period of 4 to 5 weeks that was unmatched by Comparative Example 3.

Comparative Example 3, (containing semi-crystalline PVOH), resulted in an unstable, more viscous formulation when the solution did not gel. Without being bound by any particular theory, it is believed that the semi-crystalline structure of the PVOH may cause intermolecular hydrogen bonding, forming a dense, crosslinked network and thus increasing the viscosity of the formulation. Formulations having a higher acid concentration and thus a lower pH may have a more crosslinked structure, resulting in a more viscous formulation and a more unstable viscosity, as crosslinking often occurs in a random formation. Moreover, even when varying the type and strength of acid catalyst used, Examples 3 and 4 of the present disclosure showed a much more stable composition with a lower viscosity than Comparative Example 3. Thus, these results indicate that Examples 3 and 4 may have a less crosslinked, less dense structure than Comparative Example 3, while still achieving improved barrier results (such as the OTR data previously discussed). The ability to consistently and accurately control the viscosity of the formulations of the present disclosure may allow for improved handling of the coating composition, for instance, by allowing the coating to be more precisely placed where desired. Furthermore, control of the viscosity may allow for the coating compositions to be uniformly recreated with little variance in performance and properties as compared to conventional coating compositions.

A first aspect of the present disclosure may be directed to a primer coating comprising an aqueous mixture comprising amorphous polyvinyl alcohol, an adhesion promoter comprising one or more of polyethyleneimine and polyurethane, a crosslinker, and optionally, a catalyst.

A second aspect of the present disclosure may include the first aspect, wherein the adhesion promoter comprises polyethyleneimine.

A third aspect of the present disclosure may include the first and second aspects, wherein the adhesion promoter comprises polyurethane.

A forth aspect of the present disclosure may include the first through third aspects, wherein the crosslinker is selected from the group consisting of aldehydes, dialdehydes, organic salts, inorganic salts, and combinations thereof.

A fifth aspect of the present disclosure may include the first through fourth aspects, wherein the coating comprises a catalyst and the catalyst comprises an organic or an inorganic acid catalyst or salts thereof.

A sixth aspect of the present disclosure may include the first through fifth aspects, wherein the primer coating exhibits a glass transition temperature (T_{g}) of 80° C. to 100° C. when measured according to differential scanning calorimetry (DSC).

A seventh aspect of the present disclosure may include the first through sixth aspects, wherein the primer coating exhibits a glass transition temperature (T_{g}) of 95° C. to 100° C. when measured according to DSC.

An eight aspect of the present disclosure may include the first through seventh aspects, wherein the primer coating exhibits a glass transition temperature (T_{g}) of 97° C. to 98° C. when measured according to DSC.

A ninth aspect of the present disclosure may include the first through eighth aspects, wherein the primer coating exhibits an increased glass transition temperature (T_{g}) of greater than or equal to 10° C. when compared to similar primer coatings that do not contain a crosslinker.

A tenth aspect of the present disclosure may include the first through ninth aspects, wherein the primer coating exhibits no crystalline peaks above 100° C. when measured according to DSC.

An eleventh aspect of the present disclosure may include the first through tenth aspects, wherein the primer coating exhibits a % crystallinity of less than or equal to 12% crystallinity, when calculated based on the ratio of absorbance at 1144 cm⁻¹ and 1094 cm⁻¹ as measured by attenuated total reflectance Fourier transform infrared spectroscopy (ATR FTIR).

A twelfth aspect of the present disclosure may include the first through eleventh aspects, wherein the primer coating has a viscosity of less than 200 centipoises when measured using a Brookfield LV-series viscometer, spindle 1 at 60 RPM.

A thirteenth aspect of the present disclosure may be directed towards a coated polymeric substrate comprising a polymeric substrate, and a coating disposed over the polymeric substrate, comprising amorphous polyvinyl alcohol, an adhesion promoter comprising one or more of polyethyleneimine and polyurethane, and a crosslinker.

A fourteenth aspect of the present disclosure may include the thirteenth aspect, wherein the adhesion promoter comprises polyethyleneimine.

A fifteenth aspect of the present disclosure may include the thirteenth and fourteenth aspects, wherein the adhesion promoter comprises polyurethane.

A sixteenth aspect of the present disclosure may include the thirteenth through fifteenth aspects, wherein the polymeric substrate comprises at least one of biaxially-oriented polypropylene, biaxially-oriented polyethylene terephthalate, biaxially-oriented polyamide, and biaxially-oriented polylactic acid.

A seventeenth aspect of the present disclosure may include the thirteenth through sixteenth aspects, wherein the crosslinker is selected from the group containing aldehydes, dialdehydes, organic salts, inorganic salts, and combinations thereof.

An eighteenth aspect of the present disclosure may include the thirteenth through seventeenth aspects, further comprising a metallization coating or a metal oxide disposed over the coating.

A nineteenth aspect of the present disclosure may include the thirteenth through eighteenth aspects, wherein the coated polymeric substrate has a metal adhesion bond strength to the metallization coating or the metal oxide of greater than or equal to 300 g/in when measured using ethylene acrylic acid (EAA) film at 105° C. for 20 seconds.

A twentieth aspect of the present disclosure may include the thirteenth through nineteen aspects, wherein the coated polymeric substrate exhibits an improved oxygen transmission rating (OTR) of less than or equal to 1.00 cc/m²/atm when measured using ASTM D3985 at 23° C. with 0% relative humidity.

A twenty-first aspect of the present disclosure may include the thirteenth through twentieth aspects, wherein the coating on the coated polymeric substrate does not exhibit a crystallization peak above 100° C., when measured according to DSC.

A twenty-second aspect of the present disclosure may include the thirteenth through twenty-first aspects, wherein the coating on the coated polymeric substrate exhibits a % crystallinity of less than or equal to 12% crystallinity, when calculated based on the ratio of absorbance at 1144 cm⁻¹ and 1094 cm⁻¹ as measured by ATR FTIR.

A twenty-third aspect of the present disclosure may include the thirteenth through twenty-second aspects, wherein the coating on the coated polymeric substrate exhibits an increased T_{g} of greater than or equal to 10° C. when compared to a similar coated polymeric substrate that does not contain a crosslinker.

A twenty-fourth aspect of the present disclosure may include the thirteenth through twenty-third aspects, wherein the coating exhibits a T_{g} of 80° C. to 100° C.

A twenty-fifth aspect of the present disclosure may include the thirteenth through twenty-fourth aspects, wherein the coating exhibits a T_{g} of 97° C. to 98° C.

A twenty-sixth aspect of the present disclosure may be directed towards a method of making a coated polymeric substrate comprising stretching a polymeric substrate; applying a coating to at least a first surface of the stretched polymeric substrate, wherein the coating comprises an aqueous mixture of amorphous polyvinyl alcohol, an adhesion promoter comprising one or more of polyethyleneimine and polyurethane, and a crosslinker; and curing the coating onto at least a first surface of the stretched polymeric substrate.

A twenty-seventh aspect of the present disclosure may include the twenty-sixth aspect, wherein the adhesion promoter comprises polyethyleneimine.

A twenty-seventh aspect of the present disclosure may include the twenty-sixth and twenty-seventh aspects, wherein the adhesion promoter comprises polyurethane.

A twenty-ninth aspect of the present disclosure may include the twenty-sixth through twenty-eight aspects, wherein the polymeric substrate is stretched in a machine direction orientation, a transverse direction orientation, or both.

A thirtieth aspect of the present disclosure may include the twenty-sixth through twenty-ninth aspects, further comprising applying a metallization coating or a metal oxide over the cured coating.

A thirty-first aspect of the present disclosure may include the twenty-sixth through thirtieth aspects, wherein the coated polymeric substrate exhibits an improved oxygen transmission rating of less than or equal to 1.00 cc/m²/atm when measured according to ASTM D3985 at 23° C. with 0% relative humidity.

A thirty-second aspect of the present disclosure may include the twenty-sixth through thirty-first aspects, wherein the crosslinker is selected from the group containing aldehydes, dialdehydes, organic salts, inorganic salts, and combinations thereof.

A thirty-third aspect of the present disclosure may include the twenty-sixth through thirty-second aspects, wherein curing occurs at a temperature of 120° C. to 240° C.

A thirty-forth aspect of the present disclosure may include the twenty-sixth through thirty-third aspects, wherein the coated polymeric substrate does not exhibit a crystallization peak above 100° C., when measured according to DSC.

A thirty-fifth aspect of the present disclosure may include the twenty-sixth through thirty-fourth aspects, wherein the coated polymeric substrate exhibits a % crystallinity of less than or equal to 12% crystallinity, when calculated based on the ratio of absorbance at 1144 cm⁻¹ and 1094 cm⁻¹ as measured by ATR FTIR.

A thirty-sixth aspect of the present disclosure may include the eighteenth through thirty-fifth aspects, wherein the metallization coating or metal oxide comprises aluminum or aluminum oxide.

A thirty-seventh aspect of the present disclosure may include the eighteenth through thirty-sixth aspects, wherein the metallization coating has an optical density of from 2.0 to 2.7.

A thirty-eighth aspect of the present disclosure may include the first through thirty-seventh aspects, wherein the coating comprises from 3 weight percent (wt %) to 25 wt % amorphous polyvinyl alcohol based on the total weight of the primer coating when in aqueous solution.

A thirty-ninth aspect of the present disclosure may include the first through thirty-eighth aspects, wherein the coating comprises from 0.05 wt % to 3 wt % of the adhesion promoter based on the total weight of the primer coating when in aqueous solution, and

A fortieth aspect of the present disclosure may include the first through thirty-ninth aspects, wherein the coating comprises from 0.3 wt % to 5 wt % of the crosslinker based on the total weight of the primer coating when in aqueous solution.

It should be apparent to those skilled in the art that various modifications and variations can be made to the described embodiments without departing from the spirit and scope of the claimed subject matter. Thus, it is intended that the specification cover the modifications and variations of the various described embodiments provided such modification and variations come within the scope of the appended claims and their equivalents.

What is claimed is:

1. A primer coating comprising:
an aqueous mixture comprising amorphous polyvinyl alcohol, an adhesion promoter comprising one or more of polyethyleneimine and polyurethane, a crosslinker, and optionally, a catalyst.

2. The primer coating of claim 1, wherein the adhesion promoter comprises polyethyleneimine.

3. The primer coating of claim 1, wherein the crosslinker is selected from the group consisting of aldehydes, dialdehydes, organic salts, inorganic salts, and combinations thereof.

4. The primer coating of claim 1, wherein the primer coating contains from 3 weight percent (wt %) to 25 wt % amorphous polyvinyl alcohol based on the total weight of the primer coating when in aqueous solution.

5. The primer coating of claim 1, wherein the primer coating contains from 0.05 wt % to 3 wt % of the adhesion promoter based on the total weight of the primer coating when in aqueous solution.

6. The primer coating of claim 1, wherein the primer coating contains from 0.3 wt % to 5 wt % of the crosslinker based on the total weight of the primer coating when in aqueous solution.

7. The primer coating of claim 1, wherein the primer coating exhibits a glass transition temperature (T_{g}) of 80° C. to 100° C. and does not exhibit a crystalline peak above 100° C. when measured according to differential scanning calorimetry (DSC).

8. The primer coating of claim 1, wherein the primer coating exhibits a % crystallinity of less than or equal to 12% crystallinity, when calculated based on the ratio of absorbance at 1144 cm⁻¹ and 1094 cm⁻¹ as measured by attenuated total reflectance Fourier transform infrared spectroscopy (ATR FTIR).

9. The primer coating of claim 1, wherein the aqueous mixture includes a catalyst, and the catalyst comprises an organic or an inorganic acid catalyst or salts thereof.

10. The primer coating of claim 9, wherein the primer coating comprises from 0.1 wt % to 3 wt % of the catalyst based on the total weight of the primer coating when in aqueous solution.

11. The primer coating of claim 9, wherein the catalyst comprises orthophosphoric acid, acetic acid, or combinations thereof.

12. The primer coating of claim 1, wherein the primer coating has a viscosity of less than 200 centipoises when measured using a Brookfield LV-series viscometer, spindle 1 at 60 RPM.

13. A coated polymeric substrate comprising:
a polymeric substrate, and
a coating disposed over the polymeric substrate, comprising amorphous polyvinyl alcohol, an adhesion promoter comprising one or more of polyethyleneimine and polyurethane, and a crosslinker.

14. The coated polymeric substrate of claim 13, further comprising a metallization coating or a metal oxide disposed over the coating.

15. The coated polymeric substrate of claim 14, wherein the metallization coating or metal oxide comprises aluminum or aluminum oxide.

16. The coated polymeric substrate of claim 13, wherein the polymeric substrate is selected from the group consisting of polylactic acid (PLA), polyethylene terepthalate (PET), biaxially oriented polyethylene terepthalate (BOPET), oriented polypropylene (OPP), biaxially oriented polypropylene (BOPP), biaxially oriented polyamide (BOPA) and combinations thereof.

17. A method of making a coated polymeric substrate comprising:
stretching a polymeric substrate;
applying a coating to at least a first surface of the stretched polymeric substrate, wherein the coating comprises an aqueous mixture of amorphous polyvinyl alcohol, an adhesion promoter comprising one or more of polyethyleneimine and polyurethane, and a crosslinker; and
curing the coating onto at least a first surface of the stretched polymeric substrate.

18. The method of claim 17, wherein the polymeric substrate is stretched in a machine direction orientation, a transverse direction orientation, or both.

19. The method of claim 17, further comprising applying a metallization coating or a metal oxide over the cured coating.

20. The method of claim 17, wherein curing occurs at a temperature of 120° C. to 240° C.
